(19) United States
(12) Patent Application Publication
(10) Pub. No.: US 2025/0275890 A1
(43) Pub. Date: Sep. 4, 2025

(54) VIAL ADAPTER AND VIAL ADAPTER SYSTEM AND METHOD

(71) Applicant: NORTON HEALTHCARE LIMITED, Castleford, West Yorkshire (GB)

(72) Inventors: Rebecca Shepherd, Runcorn Cheshire (GB); Ivan Jurilj, Zagreb (HR); Oliver Byrne, Runcorn Cheshire (GB); Silvestar Bingula, Zagreb (HR)

(73) Assignee: NORTON HEALTHCARE LIMITED, Castleford, West Yorkshire (GB)

(21) Appl. No.: 18/858,865

(22) PCT Filed: Apr. 24, 2023
(86) PCT No.: PCT/EP2023/060667

§ 371 Date: Oct. 22, 2024

Related U.S. Application Data
(60) Provisional application No. 63/333,623, filed on Apr. 22, 2022.

(51) Int. Cl. A61J 1/20

(52) U.S. Cl. CPC A61J 1/201; A61J 1/2051; A61J 1/2096

(57) ABSTRACT

A vial adapter may include a body extending from a proximal end to a distal end. A syringe connector configured to engage a syringe may be proximate the proximal end of the body. A cannula configured to pierce a septum of a vial may be disposed proximate the distal end of the body. A vial attachment portion may be disposed at the distal end of the body. A fluid conduit may extend from an outlet aperture at the syringe connector to the cannula. A compressible member may be disposed within the syringe connector. The syringe connector may axially compress the compressible member from an expanded configuration, in which the compressible member blocks the outlet aperture and prevents fluid flow from the fluid conduit to the syringe connector, to a compressed configuration, in which the outlet aperture is exposed.

### CROSS REFERENCE TO RELATED APPLICATIONS

This application claims priority to U.S. provisional patent application No. 63/333,623, filed Apr. 22, 2022, which is incorporated herein by reference in its entirety.

### BACKGROUND

In a medical context, connection between a syringe containing a medical substance or to be filled with a medical substance and a vial containing another medical substance is often required, for example for safety reasons, to ensure a controlled transfer of fluids, and/or mixing/reconstitution of materials just prior to administration. Furthermore, certain vial adapters allow for plural syringe attachments (e.g., whether the same or different syringe) for multiple dose applications.

Existing solutions for connecting the syringe to the vial include different vial-syringe connection devices such as syringe adaptors and vial adaptors. One such solution is described, for example, in commonly owned PCT Publication WO 2022/049110A1, published Mar. 10, 2022, and entitled Vial Adapter with Valve, the entire contents of which are incorporated herein by reference.

Within this context, there is a need for an improved solution for connecting a vial and a syringe, including limiting access, where desired, to medicament.

### SUMMARY

The application is generally related to devices and methods used for handling and manipulating fluids in a medical context, and more particularly, to vial adapters and vial adapter systems and related methods.

According to an example embodiment of the present invention, vial adapters, systems and methods may include a vial adapter configured to limit the number of times a syringe can be used with an adapter. In some examples, the vial adapters, systems and methods may additionally, or alternatively, limit the medicament dose accessible during any given syringe use.

In one example, a vial adapter may include one or more of a body extending from a proximal end to a distal end, a syringe connection at the proximal end of the body, the syringe connection configured to engage a syringe, and a cannula disposed at the distal end of the body. The cannula may have a pointed tip, for example so as to pierce a septum of a vial. The syringe connection may be a syringe connector. The vial adapter may include a vial attachment portion at the distal end of the body. The vial attachment portion may be configured to attach to the vial. The vial adapter may include a fluid conduit. The fluid conduit may extend from an outlet aperture at the syringe connector to the cannula. In some examples, the vial attachment may include a compressible member. The compressible member may be disposed within the syringe connector. Attachment of a syringe to the syringe connector may (e.g., axially) compress the compressible member. For example, the compressible member may be compressed from an expanded configuration to a compressed configuration. In the expanded configuration, the compressible member may block the outlet aperture and/or prevent fluid flow from the fluid conduit to the syringe connector. In the compressed configuration the outlet aperture may be exposed and/or the fluid conduit may be in fluid communication with the syringe connector.

In some examples, a vial adapter may include a body. The body may include (e.g., define) a proximal end and a distal end. A fluid conduit may extend through the body, for example from the proximal end to the distal end. The body may include (e.g., define) a circumferential wall at a distal end of the conduit. A cannula may be disposed proximal (e.g., at) the distal end of the body. The cannula may include a pointed tip, for example to puncture a septum of a vial. The vial adapter may additionally, or alternatively, include a vial attachment portion. The vial attachment portion may be disposed about the fluid conduit and/or configured to engage the vial. The vial adapter may include a gasket. The gasket may be disposed within and/or configured to move axially through the fluid conduit. The gasket may include a syringe connector. The syringe connector may be configured to engage a syringe and/or at least one aperture opposite from and in fluid communication with the syringe connector. The aperture may be radially offset from a center of the gasket. The gasket may be movable through the fluid conduit, for example to a distalmost position. In the distalmost position, the gasket may engage the circumferential wall, for example to block the aperture and/or prevent fluid flow from the cannula to the syringe connector portion.

In some examples, a vial adapter may include a main body. The main body may include a vial attachment portion, for example configured to engage a vial. Additionally, or alternatively, the main body may include a port, for example defining an internal thread. The vial adapter may include an attachment portion. The attachment portion may include a cannula, for example configured to extend through the main body and at least partially into the vial. Additionally, or alternatively, the attachment portion may include an external thread. The external thread may be complementary to (e.g., engage) the internal thread of the port of the main body, such that engagement of the external thread and the internal thread secures the attachment portion to the main body. Incremental advancement of the external thread along the internal thread via rotation of the attachment portion may adjust a distance the cannula extends into the vial.

Additional features and advantages are realized through the system of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Many aspects of the invention can be better understood with reference to the following drawings. The components in the drawings are not necessarily to scale, with emphasis being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details.

FIG. 1 is a schematic view of an example of a syringe and vial adapter;

FIG. 2A is a schematic view of a cam track for a vial adapter in accordance with the vial adapter of FIG. 1;

FIG. 2B is a close-up of a portion of the vial adapter cam track of FIG. 2A;

FIG. 3A is a first schematic image of an example ratchet vial adapter;

FIG. 3B is another schematic image of the example ratchet vial adapter of FIG. 3A;

FIG. 3C is another schematic image of the example ratchet vial adapter of FIG. 3A;

FIG. 3D is another schematic image of the example ratchet vial adapter of FIG. 3A;

FIG. 3E is another schematic image of the example ratchet vial adapter of FIG. 3A;

FIG. 4 is a diagram view of an example vial and vial adapter;

FIG. 5A is a cross sectional view an example vial and vial adapter;

FIG. 5B is a cross sectional view an example vial and vial adapter, in accordance with FIG. 5A;

FIG. 5C is a cross sectional view an example vial and vial adapter, in accordance with FIG. 5A;

FIG. 5D is a cross sectional view an example vial and vial adapter, in accordance with FIG. 5A;

FIG. 6A is a perspective view an example vial adapter including a dose/cannula setting;

FIG. 6B is a diagram view the example vial adapter of FIG. 6A;

FIG. 6C are cross sectional views of the example dose setting aspects of FIGS. 6A and 6B;

FIG. 7A is a first schematic image of an example ratchet vial adapter;

FIG. 7B is another schematic image of the example ratchet vial adapter of FIG. 7A;

FIG. 7C is another schematic image of the example ratchet vial adapter of FIG. 7A;

FIG. 7D is another schematic image of the example ratchet vial adapter of FIG. 7A;

FIG. 7E is another schematic image of the example ratchet vial adapter of FIG. 7A;

FIG. 7F is another schematic image of the example ratchet vial adapter of FIG. 7A; and

FIG. 7G is another schematic image of the example ratchet vial adapter of FIG. 7A.

### DETAILED DESCRIPTION OF THE INVENTION

In furtherance of the brief description provided above and associated textual detail of each of the figures, the following description provides additional details of example embodiments of the present invention.

Detailed illustrative examples are disclosed herein. However, specific functional details disclosed herein are merely representative for purposes of describing example embodiments. Examples may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed. To the contrary, example embodiments are to cover all modifications, equivalents, and alternatives falling within the scope of example embodiments.

It will be understood that, although the terms first, second, etc. may be used herein to describe various elements, steps, and/or calculations, these elements, steps, and/or calculations should not be limited by these terms. These terms are only used to distinguish one element, step, and/or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Herein, example embodiments of the present invention will be described in detail. Example embodiments of the present invention provide a vial adapter, system, and method as described below.

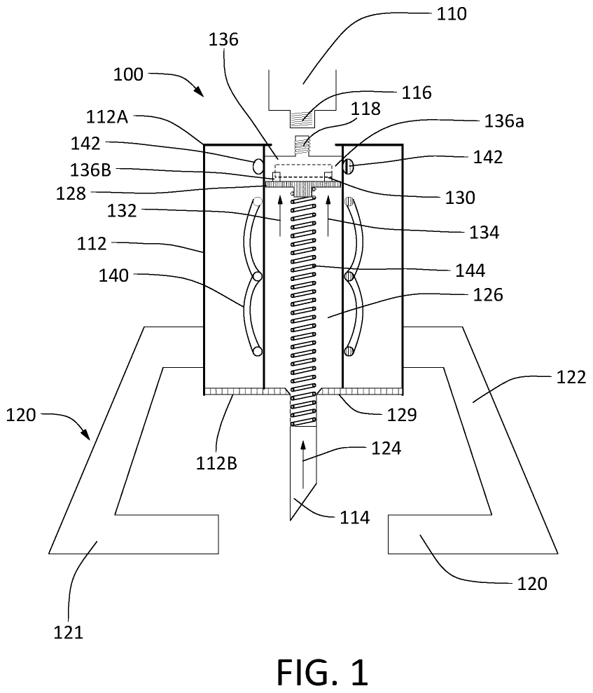

FIG. 1 illustrates an example vial adapter, shown generally at 100, along with a syringe 110 configured to connect to the vial adapter 100. The vial adapter 100 has a body, or casing, 112, that extends from a proximal end 112a to a distal end 112b. The vial adapter 100 may include a conduit 126. The conduit may extend through the body 112 from the proximal end 112a to the distal end 112b. Additionally, or alternatively, the vial adapter may include a cannula 114 and vial attachment portion 120 at the distal end 112b. In one example, the vial attachment portion 120 can include flexible arms 121, 122 laterally disposed on opposite sides of the cannula 114. Additionally, or alternatively, the vial attachment portion 120 may comprise a flexible skirt extending circumferentially about the cannula 114. The cannula 114 may be disposed at the distal end of the body 112b and/or configured with a pointed tip so as to puncture the septum of a vial (not shown in FIG. 1 but illustrated in subsequent drawings). Though depicted as a plastic spike, in some examples the cannula 114 may comprise a metal needle or other fluid conduit as desired. The syringe 110 may include connector 116, for example complementary to proximal syringe connector 118 on the gasket 136, which is described herein. The connector 116 may be a twist on connector. The vial attachment portion 120 may be disposed on the vial adapter 100, for example opposite the syringe connector 118. We note that the illustrated twist on connector is merely an example, and may include one or more of a snap on connection, a luer connection, an integral connection, etc., without limitation.

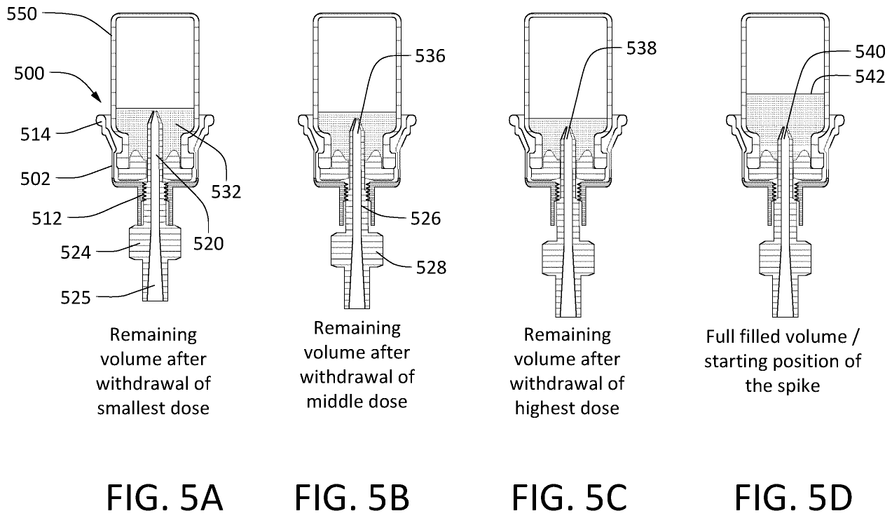

Referring still to FIG. 1, the illustrated vial adapter 100 includes a vial attachment portion 120 at the distal end 112b of the body 112. The vial attachment portion may be configured to hold a vial (e.g., vial 550 shown in FIG. 5A, for example). The vial may contain medicament. The vial may be in engagement with the vial adapter 100. In some examples, the arms 121, 122 are resilient and/or snap onto the vial when the vial is pressed against the vial adapter 100. Additionally, or alternatively, the arms and/or vial may incorporate locking features, for example preventing flexing of the arms or otherwise preventing removal of the vial after attachment. Further, in some examples, the arms may have other shapes than illustrated or attach in other ways, such as being partially threaded for easy connection, having a snap or luer connection, etc.

Referring again to the cannula 114, arrow 124 shows a direction of fluid withdrawal, for example subsequent to connection of a syringe to the vial adapter 100 and/or application of vacuum from the syringe. Alternatively, or additionally, medicament may be first provided to the vial via a first syringe attached to the vial adapter 100. As such, arrow 124 may show a direction of fluid withdrawal via a second syringe attached to the vial adapter 100, subsequent to inversion of the second syringe, vial, and vial adapter assembly by a user. Fluid flow may continue from the vial into the conduit 126 of the vial adapter 100 and/or further through apertures 128, 130 in gasket 136, for example according to fluid flow directional arrows 132, 134. The gasket may include silicone. The body 112 may include a first material and/or the gasket 136 may include at least one second material. The second material may be different than the first material. In some examples, the first material may be a plastic and/or the second material may be a silicone, but other examples are contemplated. The gasket 136 may be positioned within the conduit 126 and/or be configured to move axially within the conduit 126, for example while maintaining a fluid seal against the walls of the conduit 126. The gasket 136 may be biased away from the cannula 114 (e.g., towards the proximal end 112a of the body 112), for example by a spring 144. The spring 144 may extend through the conduit 126 and/or be anchored at the distal end 112b of the body 112. The spring 144 will be described further below. The conduit 126 may extend through the body 112 of the vial adapter 100 and/or fluidly connect the syringe connector 118 and the cannula 114. Apertures 128, 130 positioned at the distal end of the gasket 136 allow passage of fluid from the conduit 126 to a proximal fluid conduit space 138, for example within gasket 136 that may feed the fluid through proximal syringe connector 118 and/or ultimately into the syringe 110. Though gasket 136 is shown with two apertures 128, 130, the gasket 136 may include a single aperture, for example extending circumferentially about the distal end of the gasket 136 to provide access to conduit space 138. Alternatively, or additionally, the gasket 136 may include more than two apertures (e.g., three, four, five, or more apertures). As shown, the apertures 128, 130 may be radially offset from the center of the gasket 136 (e.g., and likewise radially offset from the cannula 114). The apertures 128, 130 may be axially aligned with a circumferential wall 129 at the distal end of the conduit 126 proximal to the cannula 114.

In some examples, the gasket 136 may have a monolithic body defined by one material, for example silicone. The gasket 136 may have a two-part construction (e.g., as illustrated), for example with a proximal part 136a of the gasket 136 being defined by a first material, such as plastic or silicone, and/or a distal part 136b of the gasket 136 being defined by a second material, such as a silicone or rubber. In some examples, the second material may be specifically configured (e.g., selected) for providing a fluid seal against the circumferential wall 129 (e.g., as will be described further herein).

In some examples, the vial adapter 100 may include a ratchet style cam track 140 disposed within the conduit 126. The gasket 136 may include one or more cam members 142 that can move within the cam track 140. The vial adapter 100 may include a spring 144 that may bias the gasket 136 away from the cannula 114. In some examples, the spring 144 is a coil spring, though other types of springs are contemplated. Alternatively, or additionally, the spring 144 may be positioned coaxially with the cannula 114 (e.g., radially spaced from the apertures 128, 130). As will be described in more detail below (e.g., and as shown by subsequent cam member positions in FIG. 1), in some examples, adding successive syringes may advance the cam members 142 of the gasket 136 along the cam track 140. In some examples, the gasket 136 and cam members 142 may not (e.g., cannot) be advanced to the next position until a syringe 110 is disconnected from the gasket 136 (e.g., through withdrawal of a dose of medicament and removal of the syringe). With the last syringe permitted, the cam members 142 may bottom out within the conduit 126. In this distalmost position of the gasket 136, the gasket 136 may engage the circumferential wall 129, for example to block the apertures 128, 130 and/or prevent fluid flow from the cannula 114 to the syringe connector 118. The gasket 136 may comprise more than one material. For example, in the distalmost position the distal portion 136b may engage the circumferential wall 129 (e.g., when the gasket comprises more than one material). The illustrated example allows fluid transfer between the syringe and the vial via two successive syringes and/or blocks an attempt to perform a fluid transfer via a third syringe. However, it is also contemplated that the vial adapter 100 can be configured to only allow fluid transfer via a single syringe. Also, it is contemplated that the vial adapter 100 can be configured to allow withdrawal of three or more (e.g., any number of) doses.

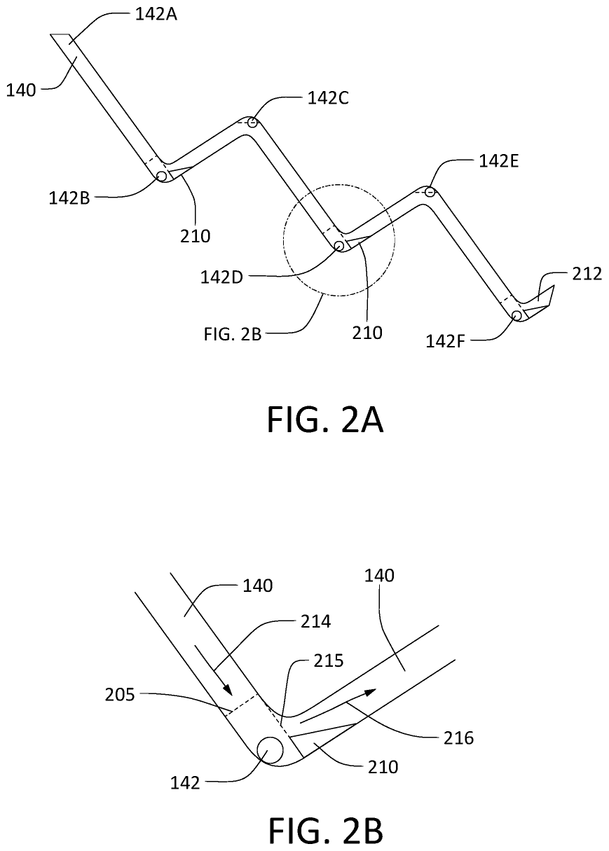

FIGS. 2A and 2B show an example cam track 140 in more detail (e.g., noting that a single cam track or plural cam tracks may be utilized). With regard to FIG. 2A, cam track 140 is shown with cam member 142 in successive positions 142A-F (e.g., which reflect the corresponding positions of the gasket 136 as it moves through the conduit 126). At positions 142B, E and F, a lodging member 210 disposed within the cam track 140 may provide a temporary stop (e.g., during dose transfer and until removal of the syringe after transfer of a dose/removal of the syringe). Once the syringe 110 is disconnected from the gasket 136, the cam member(s) may move to positions 142 C, E, for example to await attachment of the next syringe. FIG. 2B provides a close-up of the position 142D, showing the cam track 140, the movement of the cam member into position 142D at arrow 214, and subsequent movement of the cam member 142 over the lodging member 210 after removal of the syringe 110 at arrow 216 as the cam member 142 moves to position 142E (e.g., as shown in FIG. 2A). In some examples, successive movements for one or more advancements results in audible click(s) and/or tactile feedback.

The cam track 140 may include a one-way stop 205 immediately preceding position 142D. In some examples, the one-way stop 205 comprises a ledge, though other one-way stops are contemplated, such as deflectable latches, etc. The one-way stop 205 may allow the cam member 142 to easily transition from position 142C to 142D and/or (e.g., but) prevent reverse movement back to position 142C from position 142D. The one-way stop 205 may also provide a tactile and/or audial feedback to the user via interaction with the cam member 142. Though depicted immediately preceding position 142D, a similar one-way stop 205 may also be disposed immediately preceding position 142B and/or position 142F. The cam track 140 may additionally, or alternatively include a (e.g., further) one-way stop 215 (e.g., immediately) following position 142D, for example adjacent to lodging member 210. Like one-way stop 205, one-way stop 215 may comprise a ledge (e.g., though in other embodiments could be differently configured, for example as a one-way latch). The one-way stop 215 may allow the cam member 142 to easily transition out of position 142D and/or (e.g., but) prevent reverse movement back to position 142D. The one-way stop 215 may additionally, or alternatively provide a tactile and/or audial feedback to the user via interaction with the cam member 142. Though depicted immediately following position 142D, a similar one-way stop 214 may also be disposed (e.g., immediately) following position 142B.

With further reference to FIG. 2A, a method of utilizing the vial adapter with a cam track 140 is described. At position 142A, a first syringe is attached to the adapter. As the syringe is pushed or screwed onto the adapter and/or pressure is applied, the cam member 142 (e.g., which may be a sphere or other shape in the cam track) may move a (e.g., limited and/or predetermined) distance to position 142B, at which point it may be stopped by lodging member 210 for example. As the first syringe is disengaged from the gasket 136, the cam member 142 may move over lodging member 210 to position 142C at least partially under the force of spring 144. When a second syringe is attached and/or pressure is applied, the cam member 142 may advance through the cam track 140 and/or lodge at position 142D (also shown in FIG. 2B), for example against a subsequent lodging member 210. As the second syringe is disengaged, the cam member 142 may move over the lodging member 210 at least partially under the force of spring 144 to position 142E. If a third syringe is attached and pressure is applied, the cam member may move to position 142F. However, the third syringe may bottom out the gasket 136 in the cam track 140 at that point, for example via engagement between the gasket 136 and the wall 129. Alternatively, or additionally, the flow channel may close, for example as the apertures 128, 130 align with and/or are blocked by the wall 129, thus preventing flow of medicament from the cannula 114 to the syringe.

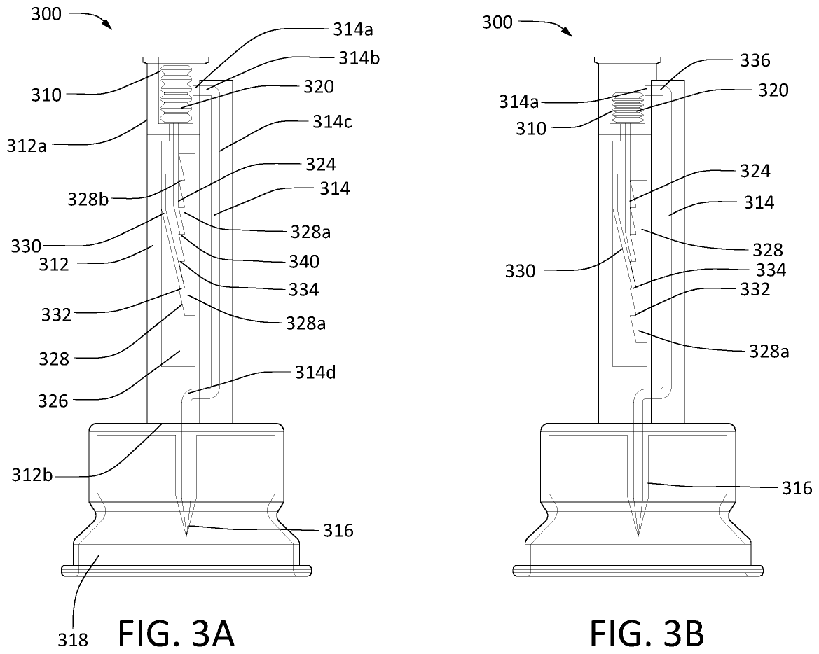

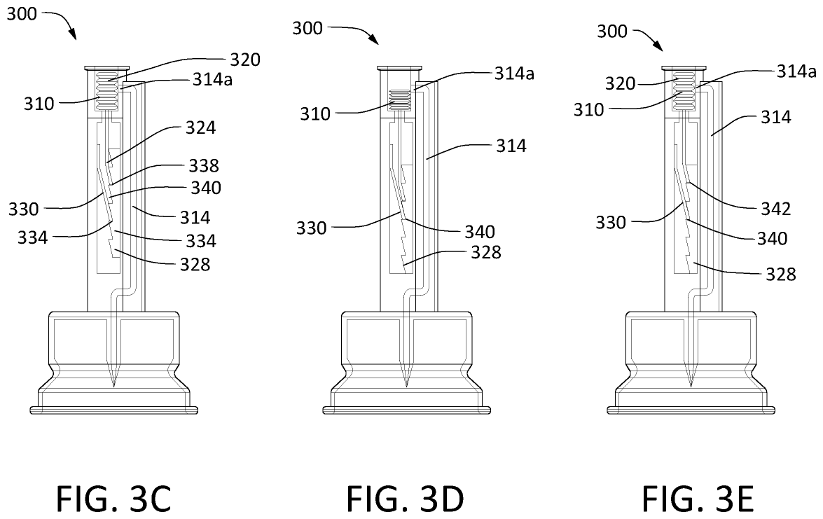

FIGS. 3A-E illustrate a vial adapter 300. Each (e.g., different) figure illustrates a different state of operation of the vial adapter 300. FIG. 3A illustrates the vial adapter state prior to attaching a syringe (e.g., syringe 110). The vial adapter 300 may include a body 312 that extends from a proximal end 312a to a distal end 312b. The vial adapter 300 may include one or more of a syringe connector 310 at the proximal end 312a of the body, a fluid conduit 314 that extends from the proximal end 312a to the distal end 312b of the body, a cannula 316 at the distal end 312b of the body 312, and a vial attachment portion 318 at the distal end 312b of the body 312 for attaching the vial adapter 300 to a vial (e.g., such as vial 550 shown in FIG. 5A, though not shown in FIGS. 3A-3E). The cannula 316 may be configured with a pointed tip so as to pierce a portion (e.g., a septum) of a vial (e.g., as shown in subsequent figures). Though depicted as a plastic spike, in other embodiments the cannula 316 may comprise a metal needle or other fluid conduit as desired. Unlike the arms illustrated as the vial attachment portions in FIG. 1, this vial attachment is illustrated as a flexible skirt that extends circumferentially about the cannula 316 and receives the vial (e.g., as a snap fit). However, it is contemplated that in other examples the vial attachment portion 318 may be configured as a screw or interference fit. As with the examples of FIG. 1, additional mechanisms for preventing removal of the vial may be included (e.g., as locking tabs, or by virtue of an interference fit itself, allowing one way attachment, but preventing removal).

Referring still to FIG. 3A, a first compressible member 320 may be attached to a movable spring 324, for example extending distally into an open cam space 326 that contains a ratcheted slider 328. The ratcheted slider 328 may be disposed within the cam space 326 and/or be axially movable through the cam space 326. The cam space 326 may be disposed axially between the syringe connector 310 and the cannula 316. As depicted, the compressible member 320 may be configured as a compressible bellows configured to form a fluid seal with the walls of the syringe connector 310 throughout compressive movement. The compressible member 320 may be positioned within the syringe connector 310. The proximal end of the movable spring 324 may be attached to the compressible member 320 and/or extend distally into the cam space 326. The movable spring 324 may be attached to the compressible member 320, such that distal compression of the compressible member 320 causes the movable spring 324 to translate distally through the cam space 326 for example. Likewise, proximal expansion of the compressible member 320 may cause the movable spring 324 to translate proximally through the cam space 326. The distal end of the movable spring 324 may be configured to engage the ratcheted slider 328. For example, the distal end of the movable spring 324 may be configured to engage teeth 328a of the ratcheted slider 328. Downward movement of the movable spring 324, for example via engagement between the movable spring 324 and a lateral surface of a tooth 328a of the ratcheted slider 328, (e.g., likewise) may force the ratcheted slider 328 to translate downwards within the cam space 326. However, (e.g., subsequent) upward movement of the movable spring 324, for example via upward expansion of the compressible member 320, may cause the distal end of the movable spring 324 to deflect laterally and/or slide over the angled surface of a tooth 328a of the ratcheted slider 328, which may result in the ratcheted slider 328 remaining in its axial position. The distal end of the movable spring 324 may deflect towards the ratcheted slider 328 and/or engage the lateral surface of a tooth 328a proximal to the tooth 328a with which it was previously engaged, for example upon full expansion of the compressible member 320.

The vial adapter 300 may additionally, or alternatively include a fixed spring 330, for example to prevent reverse movement of the ratcheted slider 328 upon expansion of the compressible member 320 following ratcheted slider 328 downward movement. The fixed spring 330 may be disposed within the cam space 326 and/or attached to the body 312. For example, a proximal end of the fixed spring 330 may be fixedly secured to a wall of the cam space 326. When the movable spring 324 moves distally to translate the ratcheted slider 328 distally, the distal end of the fixed spring 330 may deflect laterally, for example to slide over an angled surface of a tooth 328a of the ratcheted slider 328 and/or (e.g., subsequently) deflect towards the ratcheted slider to engage a lateral surface of a subsequent tooth 328a. This engagement between the fixed spring 330 and the ratcheted slider 328 may hold the ratcheted slider 328 axially in place during upward movement of the movable spring 324, for example preventing proximal movement of the ratcheted slider 328. That the movable spring 324 and/or fixed spring 330 may be elongate pieces metal or another material that may provide sufficient push and hold for the illustrated ratcheted slider 328, for example while still allowing for lateral deflection via deformation.

As depicted, the ratcheted slider 328 may define five ratchet positions for the movable spring 324 and/or the fixed spring 330 to engage the ratcheted slider 328. Each discrete ratchet position may include (e.g., be defined by) a distinct tooth 328a of the ratcheted slider 328. For example, a tooth 328a may include a lateral surface 328b of a tooth 328a of the ratcheted slider 328. The teeth 328a of the ratcheted slider may be positioned axially along the ratcheted slider 328. In one example, the ratcheted slider may include (e.g., may define) one or more of, from distal-most position to proximal-most position, a lowest ratchet position 332, a second lowest ratchet position 334, a third ratchet position 340, a second ratchet position 338, and a first ratchet position 342. However, it is contemplated that in other embodiments the ratcheted slider 328 can have more or less ratchet positions than shown presently, for example as dictated by the intended number of syringe connections for a particular implementation.

FIG. 3B illustrates the adapter 300 in a state with a syringe (e.g., syringe 110 in FIG. 1) attached (e.g., though for convenience, the syringe is not illustrated, though the compressible member 320 is shown compressed as if the syringe connector were compressing it). The attachment may be by one or more of interference fit, snap on, screw on, etc., for example between the syringe and the syringe connector 310 at this proximal portion. The vial adapter 300 may include a fluid conduit 314, for example that fluidly connects the syringe connector 310 to the cannula 316. The fluid conduit 314 may include one or more of an output aperture 314a open to the syringe connector 310, a lateral extension 314b extending from the output aperture 314a to the axial extension 314c, an axial extension 314c, and an input extension 314d that connects the cannula 316 to the axial extension. The axial extension 314c of the fluid conduit 314 may be laterally offset from the cam space 326 and/or the cannula 316, for example where the axial extension 314c comprises a majority of the length of the fluid conduit 314. However, it is contemplated that in other embodiments, the cannula 316 (e.g., along with vial attachment portion 318) may be repositioned, for example so as to be coaxial with the cam space 326 and/or the axial extension 314c of the fluid conduit 314. In a first (e.g., initial) position, the compressible member 320 may block the output aperture 314a, thus for example preventing fluid flow from the vial and cannula 316 and out of the syringe connector 310. However, connection of a syringe to the syringe connector 310 may compress the compressible member 320 distally such that, for example the output aperture 314a is exposed and in fluid communication with the syringe. Fluid may be (e.g., therefore) permitted to flow from the vial, through the cannula 316 and fluid conduit 314, and/or through syringe connector 310 to the syringe. The compressible member 320 may expand to its first (e.g., initial) position, thus again blocking the output aperture 314a, for example upon syringe removal from the vial adapter 300.

As shown in FIG. 3A, in a first (e.g., initial) state with the compressible member 320 in an expanded state, the movable spring 324 may engage the ratcheted slider 328 in the third ratchet position 340, for example while the fixed spring 330 engages the ratcheted slider 328 in the lowest ratchet position 332. As shown in FIG. 3B, attachment of a first syringe to the vial adapter 300 may cause the compressible member 320 to compress, for example moving the ratcheted slider 328 distally through displacement of the movable spring 324. This may cause the fixed spring 330 to deflect laterally, for example over the bottommost tooth 328a of the ratcheted slider 328 and/or move from the lowest ratchet position 332 to the second lowest ratchet position 334. As stated previously, in this position the compressible member 320 may be compressed such that the output aperture 314a is exposed to the syringe connector 310 and/or the first syringe, for example allowing for fluid flow through the fluid conduit 314 between the vial and the first syringe. FIG. 3C shows a third configuration of the vial adapter, with the first syringe removed. As noted, compressible member 320 may be in an expanded state (e.g., no syringe attached, and in some examples blocking fluid flow through fluid conduit 314 via output aperture 314a). In this state, the fixed spring 330 may be (e.g., still) in the second lowest ratchet position 334, but, for example the movable spring 324 may be retracted to the second ratchet position 338 from the third ratchet position 340. The movable spring 324 may be retracted to the second ratchet position 338 from the third ratchet position 340 by virtue of the holding power of fixed spring 330 on the ratcheted slider 328.

FIG. 3D shows a fourth position of the vial adapter 300, with a second syringe attached (as with FIG. 3B, above) to the syringe connector 310. Attachment of the second syringe may (e.g., further) advance the ratcheted slider 328 via downward movement of the movable spring 324, for example such that the fixed spring 330 moves into the third ratchet position 340 of the ratcheted slider 334. Additionally, or alternatively, (e.g., as herein), in some examples, compression of the compressible member 320 may unblock the output aperture 314a and/or allow fluid flow through the fluid conduit 314 between the second syringe and the vial.

FIG. 3E illustrates an additional state after removal of the second syringe from the vial adapter 300. Fixed spring 330 may remain at the third ratchet position 340, and/or the movable spring may (e.g., now) be at the first ratchet position 342. Additionally, or alternatively, as with FIG. 3C, compressible member (e.g., and/or safety valve) 320 may be in an expanded state (e.g., no syringe attached, and in some examples blocking fluid flow via output aperture 314a). At this point, the vial adapter 300 may be prevented from use with a third syringe, for example since in this position the distal end of the ratcheted slider 328 engages a distal end of the cam space 326 which may prevent further downward movement of the ratcheted slider 328. As a result, the movable spring 324 may be prevented from moving distally via engagement with the ratcheted slider 328. The compressible member 320 (e.g., likewise) may be prevented from compressing, and/or may (e.g., permanently) block the outlet aperture 314a and fluid flow to the syringe connector 310 from the fluid conduit 314.

With further reference to FIGS. 3A-E, an example method of using the vial adapter 300 may include attaching a first syringe, for example resulting in moving the compressible member 320 down. Additionally, or alternatively, attaching a first syringe may result in the ratcheted slider 328 pushing the fixed spring 330 into a locked position during use (e.g., as at FIGS. 3A-3B, into locked position at 334). This may (e.g., then) open up the fluid conduit, for example for transfer of fluid from the prefilled syringe (PFS) and to the vial through the fluid conduit 314. At FIG. 3C, the first syringe may be removed, and the movable spring 324 may slide up to the second ratchet position 338 (e.g., due to the lack of presence of a syringe). At FIG. 3D, a second syringe may be inserted, for example causing sliding of the ratchet 328 downwards and/or (e.g., also) moving the fixed spring 330 to the third ratchet position 340. Alternatively, or additionally, insertion of a second syringe may also result in opening the fluid flow through conduit 314. At this point, medicament (e.g., a reconstituted drug comprising the mixed components of the PFS and the vial) may be withdrawn from the vial into the second syringe, and/or removed from the vial adapter 300 (e.g., resulting in the configuration shown in FIG. 3E). At FIG. 3E, the vial adapter 300 may be locked out by virtue of the position of the ratcheted slider 328 within the cam space 326 and/or may not accept a third syringe in some examples.

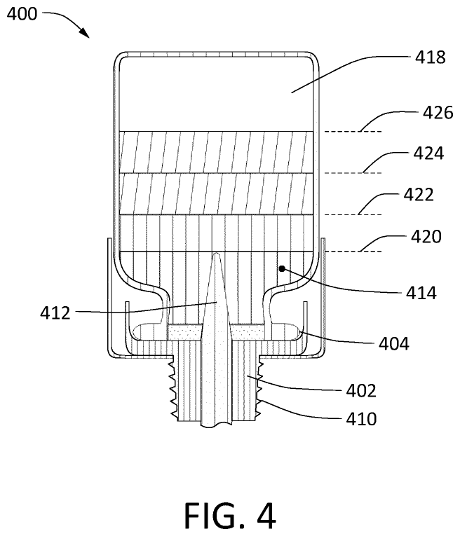

FIG. 4 illustrates another example of a vial adapter 400, for example with a predetermined or settable cannula length to allow for accurate dose amounts. The vial adapter 400 may include a body 402 that, for example may include a screw type syringe attachment 410 for receiving a syringe, though as with the above, any manner of attachment is contemplated, (e.g., luer, snap on, etc., including additional intermediate attachments, as desired). The vial adapter 400 may (e.g., also) include a cannula 412 extending from the body 402. The cannula 412 may include a pointed tip, for example to pierce the septum of and at least partially extend into a vial, as shown in FIG. 4. In this illustrated embodiment, various dose levels and/or cannula 412 lengths are contemplated, for example accounting for overfill 414 around the cannula 412 intrusion into the vial 416. Example doses are marked off in FIG. 4, accounting for anticipated air/gas 418, and/or a range of doses from 0.0 milliliters (ml) (420), to 0.9 ml (422), to 1.2 ml (424) to 1.7 ml (426). In some examples, the cannula length may be set to a particular dose withdrawal, and/or may be set at a minimum set distance or within a range with a minimum distance, for example that will ensure that overfill 414 cannot be withdrawn by a user. Though depicted as a plastic spike, in other embodiments the cannula 412 may comprise a metal needle and/or other fluid conduit as desired. The vial adapter 400 may (e.g., also) include a vial attachment portion 404, for example for attaching the vial adapter 400 to a vial. The vial attachment portion 404 may include one or more (e.g., a plurality of) snap-fit features for engaging the vial, though other examples are contemplated.

With further reference to FIG. 4, in some examples allowing for setting of a dose, (e.g., as with an insulin or other injection pen when setting a dose), a rotation and/or other mechanism may be used to adjust the dose, for example with a first dose being 1.7 ml (426 in FIG. 4, being the lowest length of the cannula 412). Other dose options may include 1.2 ml (424) or 0.9 ml (422), settable (e.g., via rotation of a vial adapter screw or other mechanism), for example with the cannula being higher for those doses. In some examples, adjustment (e.g., rotation) may only be permitted in a single direction to prevent reverse changes to the length of the cannula for dosing. In additional examples, the adjustment mechanism and/or adapter may have markings indicating dose levels.

FIGS. 5A-D show vial adapter 500 and vial 550, (e.g., similar to the embodiment described with regard to FIG. 4) with further examples of settable cannulas. FIG. 5A shows a vial 500 having a two part construction including a main body 502 and attachment 524. The main body 502 may include a vial attachment portion 514, for example for connecting the vial adapter 500 to the vial 550. The vial attachment portion 514 may comprise a flexible skirt, for example configured to circumferentially surround a portion of the vial 550 and/or releasably engage the file (e.g., through a snap fit). Alternatively, or additionally, the vial attachment portion 514 may comprise one or more (e.g., a plurality of) flexible arms, for example configured to releasably engage the vial 550. The main body 502 may (e.g., also) include a port 512, for example at an end of the main body 502 opposite the vial attachment portion 514. The port 512 may be configured to adjustably engage the attachment 524, as described herein.

The adjustment member 524 may comprise a cannula 526, for example configured to extend through the main body 502 of the vial adapter 500 and/or at least partially into the vial 550 for drawing fluid from the vial 550. The cannula 526 may have a pointed tip, for example to pierce a septum of the vial 550. Though depicted as a plastic spike, in some examples the cannula 526 may comprise a metal needle and/or other fluid conduit as desired. In some examples, at an end opposite the cannula 526, the adjustment member 524 may define a port 525. The port 525 may be configured to receive a device for receiving the liquid transferred from the vial (e.g., a syringe tip, etc.). The adjustment member 524 may comprise an external threading 526, for example configured to engage complementary threading defined in the port 512 of the main body 502 for adjustably attaching the adjustment member 524 to the main body 502. By screwing the adjustment member 524 further into or further out of the main body 502, the cannula 520 may be extended into the vial 550 by variable lengths, for example (e.g., thus) allowing a user to adjust the maximum intended dose to be drawn from the vial 550. The adjustment member 524 may (e.g., also) include a hub 528. The hub may be of increased diameter and/or be configured to engage the main body 502, for example to define the maximum extension of the cannula 520 into the vial 550.

With regard to the example of FIG. 5A, the cannula 520 may set to a smaller dose, for example by screwing the adjustment member 524 to the main body 502 to the greatest extent (e.g., until the hub 528 engages the main body 502). The remaining volume is illustrated in space 522. FIG. 5B shows the configuration of FIG. 5A, but with a middle dose setting (e.g., see set cannula length at 526). FIG. 5C shows the configuration of FIG. 5A, but with a large dose setting, as it relates to cannula length, which is shown for example at 528. FIG. 5D shows a reference image of an initial cannula setting 530 (e.g., before dose selection and with full medicament (e.g., level shown at 42) in the vial. FIGS. 5B and 5C represent positions where the adjustment member 524 may be incrementally screwed out of the main body 502, for example to increase the dose capable of being drawn from the vial 550.

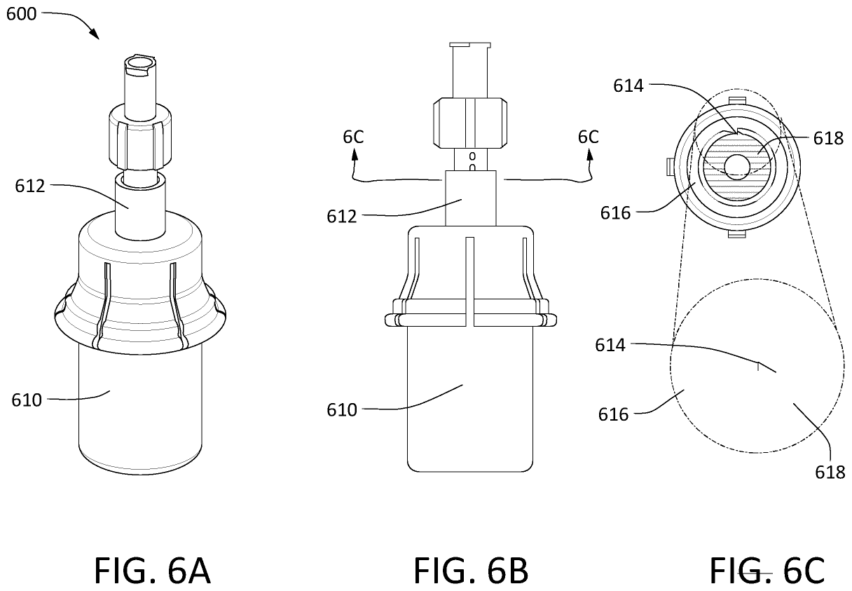

FIGS. 6A-C illustrate example cannula and/or dose setting aspects generally at 600 that may, for example, be integrated with and/or be in line with the presently described vial adapter. With reference to FIG. 6A, the adapter 610 may include a cannula dose setting member 612. This is shown again at FIG. 6B in a schematic, with the cannula and/or dose setting member 612 at (e.g., on) a distal portion. In the illustrated example, a tooth 614 on a rotatable member 616 may prevent backwards rotation relative to a fixed member 618 and/or determine the position of the cannula and/or dose, as in FIGS. 4-5D.

A vial adapter may be configured to prevent the withdrawal of a second dose of fluid from a vial and/or may prevent the attachment of an additional dosing syringe (e.g., a second or third dosing syringe) subsequent to detachment of a first dosing syringe. For instance, the vial adapter may include a block pin that prevents withdrawal of fluid from the vial after a first dosing syringe is detached from the vial adaptor. The vial adaptor may be configured to incrementally move the block pin downward, toward the vial attachment portion along a plurality of block pin positions, where each block pin position may be based on a position of a ratcheted slider of the vial adaptor. The block pin may be configured to move downward into a pin channel that is coupled to the fluid channel between the syringe attachment portion and the vial attachment portion of the vial adaptor. As such, after the attachment of a predetermined number of syringes to the vial adaptor, the block pin may be moved to the position where the block pin blocks the fluid channel between the vial and the syringe.

For instance, in some examples, the vial adaptor may be configured to allow a first syringe (e.g., such as a prefilled syringe (PFS) comprising fluid) to be attached to the vial adaptor to transfer fluid into the vial (e.g., such as those used in combination products and vaccines), and a second syringe (e.g., a first dosing syringe) to be attached to the vial adaptor to withdraw a dose of fluid from the vial. During each attachment and/or remove of the respective first and second syringes, the block pin may be incrementally adjusted toward a blocking position where the block pin blocks the fluid channel between the vial and the syringe. After the attachment of a third syringe (e.g., a second dosing syringe), the block pin may be moved into a position where it blocks the fluid channel. This may be done to prevent the accidental withdraw of a second dose of fluid from the vial. Thereafter, when the third syringe is removed, the ratcheted slider may be in a position where it prevents the attachment of an additional syringe (e.g., a fourth syringe or a third dosing syringe). Accordingly, the vial adaptor may be configured to prevent the withdrawal of a second dose of fluid from the vial and/or may be configured to prevent the attachment of a third dosing syringe. As such, the vial adaptor may prevent the withdrawal of a second dose of fluid from the vial and/or may prevent additional syringes from being attached to the vial adaptor, which may reduce or prevent an undesired additional dosing of fluid to a patient.

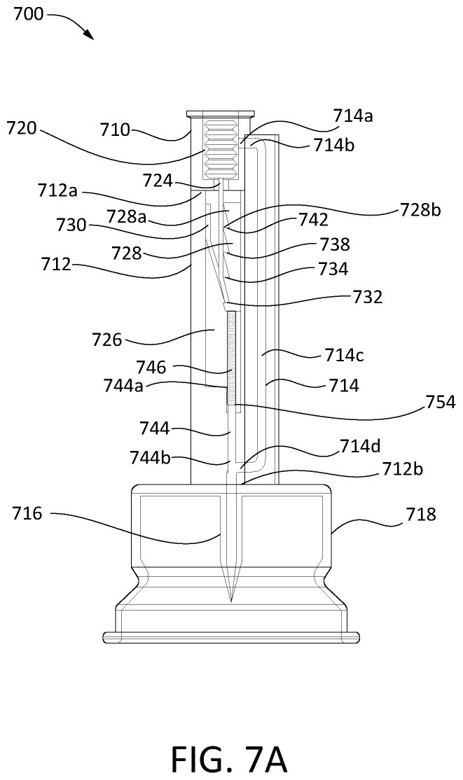

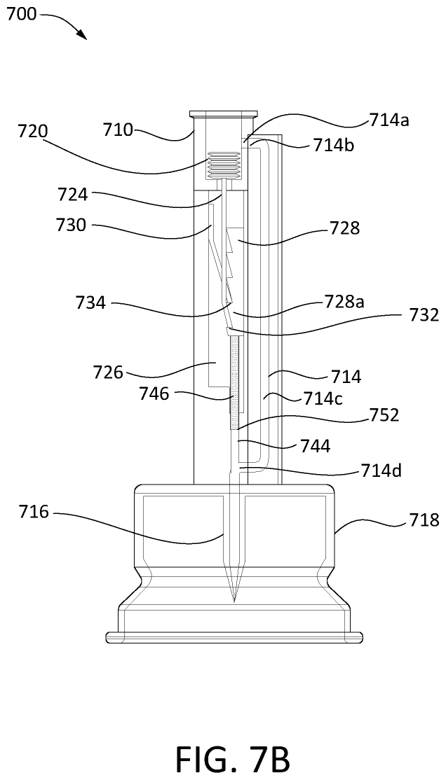

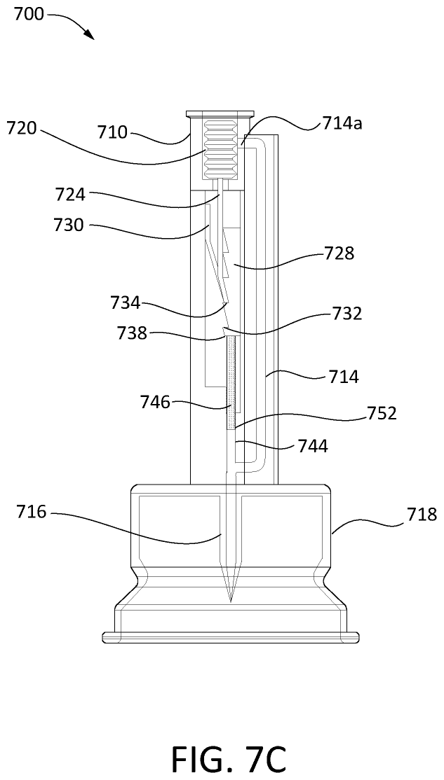

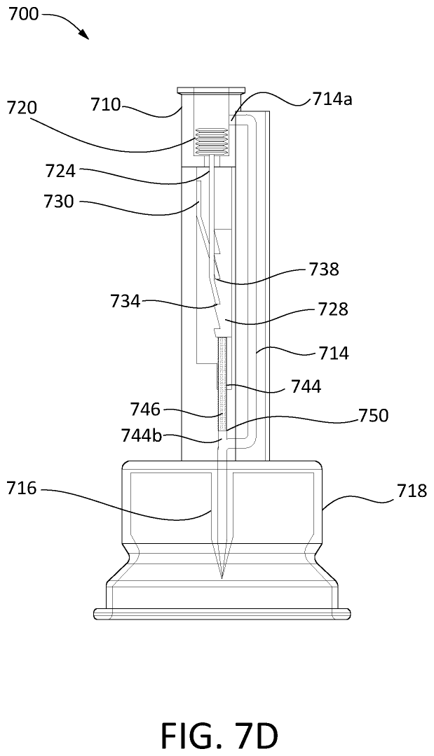

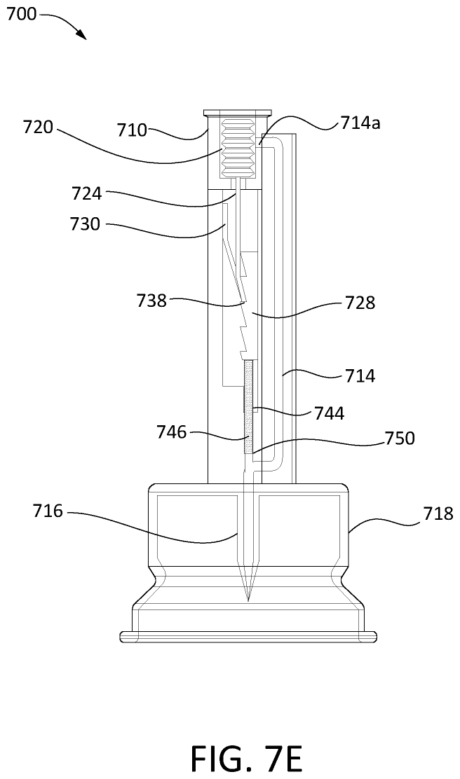

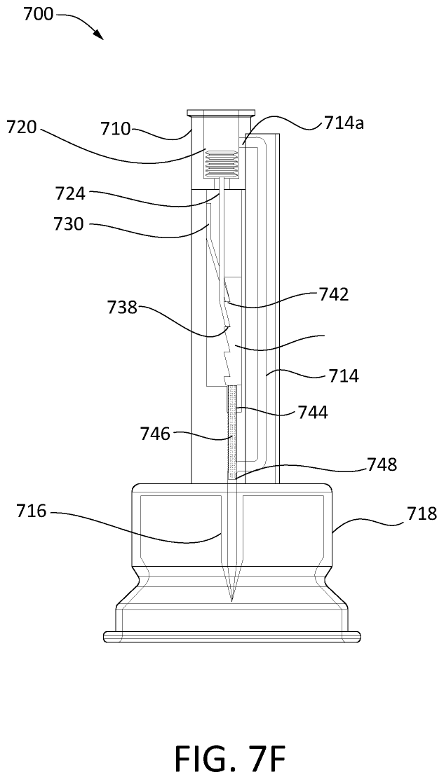

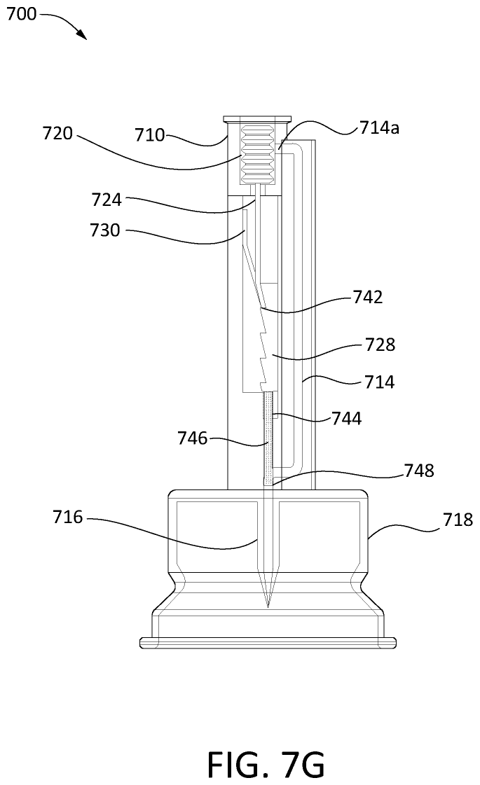

FIGS. 7A-G illustrate a vial adapter 700. Each of FIGS. 7A-7G illustrate the vial adapter 700 in a different state of operation. FIG. 7A illustrates the vial adapter state prior to attaching a syringe (e.g., syringe 110). The vial adapter 700 may include a body 712 that extends from a proximal end 712a to a distal end 712b. The vial adapter 700 may include a syringe connector 710 at the proximal end 712a of the body, a fluid conduit 714 that extends from the proximal end 712a to the distal end 712b of the body, a cannula 716 at the distal end 712b of the body 712, and a vial attachment portion 718 at the distal end 712b of the body 712 for attaching the vial adapter 700 to a vial (e.g., such as vial 550 shown in FIG. 5A, though not shown in FIGS. 7A-7G).

The cannula 716 may be configured with a pointed tip, for example, that enables the vial adapter 700 to pierce a portion (e.g., a septum) of a vial (e.g., as shown in prior figures). Though depicted as a plastic spike, in other embodiments the cannula 716 may comprise a metal needle or other fluid conduit as desired. Unlike the arms illustrated as the vial attachment portions in FIG. 1, the vial attachment portion 718 is illustrated as a flexible skirt that extends circumferentially about the cannula 716 and receives the vial (e.g., as a snap fit). However, it is contemplated that in other examples the vial attachment portion 718 may be configured as a screw or interference fit.

A pin channel 744 may include a first end 744a and a second end 744b. A block pin 746 may be at least partially disposed within an interior of the pin channel 744. For example, the block pin 746 may be disposed within the interior of the pin channel 744 proximate the first end 744a. The block pin 746 may contact (e.g., abut) a ratcheted slider 728. For example, the block pin 746 may contact (e.g., abut) the ratcheted slider 728 in a first pin position 754, or may be integrally connected to or monolithically formed with the ratcheted slider 728. The second end 744b may extend towards the distal end 712b of the body and/or the cannula 716. As with the examples of FIG. 1, additional mechanisms for preventing removal of the vial may be included as part of the vial adapter 700 (e.g., as locking tabs, or by virtue of an interference fit itself, allowing one way attachment, but preventing removal).

Referring still to FIG. 7A, a first compressible member 720 may be attached to a movable spring 724, for example extending distally into an open cam space 726 that contains the ratcheted slider 728. The ratcheted slider 728 may be disposed within the cam space 726 and/or be axially movable through the cam space 726. The cam space 726 may be disposed axially between the syringe connector 710 and the cannula 716. As depicted, the compressible member 720 may be configured as a compressible bellows configured to form a fluid seal with the walls of the syringe connector 710 throughout compressive movement. The compressible member 720 may be positioned within the syringe connector 710.

The proximal end of the movable spring 724 may be attached to the compressible member 720 and/or extend distally into the cam space 726. The movable spring 724 may be attached to the compressible member 720, such that distal compression of the compressible member 720 causes the movable spring 724 to translate distally through the cam space 726 for example. Likewise, proximal expansion of the compressible member 720 may cause the movable spring 724 to translate proximally through the cam space 726. The distal end of the movable spring 724 may be configured to engage the ratcheted slider 728. For example, the distal end of the movable spring 724 may be configured to engage teeth 728a of the ratcheted slider 728. Downward movement of the movable spring 724, for example via engagement between the movable spring 724 and a lateral surface 728b of a tooth 728a of the ratcheted slider 728, (e.g., likewise) may force the ratcheted slider 728 to translate downwards within the cam space 726. However, (e.g., subsequent) upward movement of the movable spring 724, for example via upward expansion of the compressible member 720, may cause the distal end of the movable spring 724 to deflect laterally and/or slide over the angled surface of a tooth 728a of the ratcheted slider 728, which may result in the ratcheted slider 728 remaining in its axial position. The distal end of the movable spring 724 may deflect towards the ratcheted slider 728 and/or engage the lateral surface of a tooth 728a proximal to the tooth 728a with which it was previously engaged, for example upon full expansion of the compressible member 720.

The vial adapter 700 may additionally, or alternatively include a fixed spring 730, for example to prevent reverse movement of the ratcheted slider 728 upon expansion of the compressible member 720 following the downward movement of the ratcheted slider 728. The fixed spring 730 may be disposed within the cam space 726 and/or attached to the body 712. For example, a proximal end of the fixed spring 730 may be fixedly secured to a wall of the cam space 726. When the movable spring 724 moves distally to translate the ratcheted slider 728 distally, the distal end of the fixed spring 730 may deflect laterally, for example to slide over an angled surface of a tooth 728a of the ratcheted slider 728 and/or (e.g., subsequently) deflect towards the ratcheted slider to engage a lateral surface of a subsequent tooth 728a. This engagement between the fixed spring 730 and the ratcheted slider 728 may hold the ratcheted slider 728 axially in place during upward movement of the movable spring 724, for example preventing proximal movement of the ratcheted slider 728. The movable spring 724 and/or fixed spring 730 may be elongate pieces metal or another material that will provide sufficient push and hold for the illustrated ratcheted slider 728, while still allowing for lateral deflection via deformation.

As depicted, the ratcheted slider 728 may define a plurality of ratchet positions (e.g., four ratchet positions) for the movable spring 724 and/or the fixed spring 730 to engage the ratcheted slider 728. Each ratchet position may include (e.g., be defined by) a distinct tooth 728a of the ratcheted slider 728. For example, a tooth 728a may include a lateral surface of a tooth 728a of the ratcheted slider 728. The teeth 728a of the ratcheted slider 728 may be positioned axially along the ratcheted slider 728. In one example, the ratcheted slider 728 may include (e.g., may define) one or more of, from distal-most position to proximal-most position, a lowest ratchet position 732, a second lowest ratchet position 734, a second ratchet position 738, and a first ratchet position 742. However, it is contemplated that in other embodiments the ratcheted slider 728 can have more or less ratchet positions than shown presently, for example as dictated by the intended number of syringe connections for a particular implementation.

FIG. 7B illustrates the vial adapter 700 in a state with a syringe (e.g., syringe 110 in FIG. 1) attached (e.g., though for convenience, the syringe is not illustrated, though the compressible member 720 is shown compressed as if the syringe were compressing it). The attachment of the syringe to the vial adapter 700 may be by one or more of interference fit, snap on, screw on, Luer lock, etc., for example between the syringe and the syringe connector 710 at this proximal portion.

The vial adapter 700 may include a fluid conduit 714, for example that fluidly connects the syringe connector 710 to the cannula 716. The fluid conduit 714 may include one or more of an output aperture 714a open to the syringe connector 710, a lateral extension 714b extending from the output aperture 714a to the axial extension 714c, an axial extension 714c, and an input extension 714d that connects the cannula 716 to the axial extension. The axial extension 714c of the fluid conduit 714 may be laterally offset from the cam space 726 and/or the cannula 716, for example where the axial extension 714c comprises a majority of the length of the fluid conduit 714. However, it is contemplated that in other embodiments, the cannula 716 (e.g., along with vial attachment portion 718) may be repositioned, for example so as to be coaxial with the cam space 726 and/or the axial extension 714c of the fluid conduit 714.

In a first (e.g., initial) position, the compressible member 720 may block the output aperture 714a, thus for example preventing fluid flow between the cannula 716 and the syringe connector 710. However, connection of a syringe to the syringe connector 710 may compress the compressible member 720 distally such that, for example the output aperture 714a is exposed and in fluid communication with the syringe. Fluid may be (e.g., therefore) permitted to flow between the vial and syringe through the cannula 716 and fluid conduit 714. The pin channel 744 may be fluidly connected to the cannula 716 and/or the fluid conduit 714. For example, the pin channel 744 may be connected to the input extension 714d. The compressible member 720 may expand to its first (e.g., initial) position, thus again blocking the output aperture 714a, for example upon syringe removal from the vial adapter 700. In some examples a syringe may be attached to inject a diluent or excipient into the fluid conduit, through the cannula, and into a vial containing a medicament. Subsequently, a second syringe may be attached to withdraw (e.g., diluted or reconstituted) medicament through the cannula and fluid conduit and into the second syringe. The second syringe may be removed from the vial adapter for use on a user.

As shown in FIG. 7A, in a first (e.g., initial) state with the compressible member 720 in an expanded state, the movable spring 724 may engage the ratcheted slider 728 in the lowest ratchet position 732, for example while the fixed spring 730 may engage the ratcheted slider 728 in the lowest ratchet position 732. As shown in FIG. 7B, attachment of a first syringe to the vial adapter 700 may cause the compressible member 720 to compress, for example moving the ratcheted slider 728 distally through displacement of the movable spring 724. This may cause the fixed spring 730 to deflect laterally, for example over the second bottommost tooth 728a of the ratcheted slider 728 and/or move from the lowest ratchet position 732 to the second lowest ratchet position 734. As stated previously, for example as in FIG. 7B, the compressible member 720 may be compressed such that the output aperture 714a is exposed to the syringe connector 710 and/or the first syringe, for example allowing for fluid flow from the cannula 716, through the fluid conduit 714, and to the first syringe. The block pin 746 may move downward (e.g., toward the second end 744b of the pin channel 744), for example pushed downward by the ratcheted slider 728. The block pin 746 may enter the interior of the pin channel 744, for example at a second pin position 752. Alternatively, the block pin 746 may initially reside at least partially within the pin channel 744, and be further disposed within the pin channel 744 at second pin position 752.

FIG. 7C shows a third configuration of the vial adapter 700, with the first syringe removed. As noted, the compressible member 720 may be in an expanded state (e.g., no syringe attached, and in some examples blocking fluid flow through fluid conduit 714 via output aperture 714a). In this state, the fixed spring 730 may be (e.g., still) in the second lowest ratchet position 734, but, for example the movable spring 724 may be retracted to the second lowest ratchet position 734 from the lowest ratchet position 732. The movable spring 724 may be retracted to the second lowest ratchet position 734 from the lowest ratchet position 732 by virtue of the holding power of fixed spring 730 on the ratcheted slider 728. The first syringe may be a prefilled syringe containing a diluent or excipient. The block pin 746 may remain in the second pin position 752.

FIG. 7D shows a fourth position of the vial adapter 700, with a second syringe attached (as with FIG. 7B, above) to the syringe connector 710. The second syringe may be a first dosing syringe. The first dosing syringe may be attached at the syringe connector and subsequently used to withdraw fluid from the vial. The ratcheted slider 728 may advance (e.g., further advance) downward in response to the second syringe being attached to the syringe connector 710. For example, the ratcheted slider 728 may advance downward in response to the downward movement of the moveable spring 724 that occurs when the second syringe is attached to the syringe connector 710. The advancement of the ratcheted slider 728 may cause the fixed spring 730 to move into the second ratchet position 738 of the ratcheted slider 734. The movable spring 724 may be (e.g., still) in the second lowest ratchet position 734. Additionally, or alternatively, (e.g., as herein), in some examples, compression of the compressible member 720 may unblock the output aperture 714a and/or allow fluid flow to the second syringe via fluid conduit 714. The block pin 746 may move (e.g., further) downward (e.g., further toward the second end 744b of the pin channel 744), for example pushed downward by the ratcheted slider 728. The block pin 746 may move further downward the interior of the pin channel 744, for example to a second lowest pin position 750. For example, the block pin may iteratively move downward in the pin channel toward the vial attachment portion. Since the block pin is contacted by the ratcheted slider, which also moves downward toward the vial attachment portion, the ratcheted slider may push the block pin a distance (e.g., equal to the distance the ratcheted slider moves) with each iterative movement of the ratcheted slider. In a lowest position, the block pin may block the input extension and/or the cannula. When the input extension and/or cannula is blocked by the block pin, fluid may not be drawn into the fluid conduit. This prevents an unintended dosage by a user.

FIG. 7E illustrates an additional state after removal of the second syringe (e.g., first dosing syringe) from the vial adapter 700. The fixed spring 730 may remain at the second ratchet position 738, and/or the movable spring 724 may (e.g., now) be at the second ratchet position 738. Additionally, or alternatively, as with FIG. 7C, the compressible member (e.g., and/or safety valve) 720 may be in an expanded state (e.g., no syringe attached, and in some examples blocking fluid flow via output aperture 714a). The compressible member 720 (e.g., likewise) may be prevented from compressing, and/or may block the outlet aperture 714a and fluid flow to the syringe connector 710 from the fluid conduit 714. The block pin 746 may remain in the second lowest pin position 750.

FIG. 7F shows a sixth position of the vial adapter 700, with a third syringe attached (as with FIGS. 7B and 7D, above) to the syringe connector 710. The third syringe may be a second dosing syringe. In some examples, in order to avoid an unintended dose, the third syringe may not be able to withdraw fluid (e.g., an additional dose) from the vial via the vial adapter. The block pin may advance to a lowest position with each movement of the ratcheted slider until the block pin blocks the input extension and/or the cannula. When the input extension and/or cannula is blocked by the block pin, fluid may not be drawn into the fluid conduit, which avoids an unintentional dosage. Additionally, or alternatively, the outlet aperture may be blocked, for example by the compressible member, which also may prevent withdraw of fluid from the vial. The position of the ratcheted slider, the compressible member, and/or the block pin may make a second dosage withdraw from the vial impossible. This may be for user safety, as a user may otherwise mistakenly withdraw a second dose.

Attachment of the second syringe may (e.g., further) advance the ratcheted slider 728 via downward movement of the movable spring 724, for example such that the fixed spring 730 moves into the first ratchet position 742 of the ratcheted slider 734. The movable spring 724 may be (e.g., still) in the second ratchet position 738. Additionally, or alternatively, (e.g., as herein), in some examples, compression of the compressible member 720 may unblock the output aperture 714a and/or allow fluid flow to the second syringe via fluid conduit 714. The block pin 746 may move (e.g., further) downward (e.g., further toward the second end 744b of the pin channel 744), for example pushed downward by the ratcheted slider 728. The block pin 746 may move further downward the interior of the pin channel 744, for example to the second end 744b of the pin channel 744. For example, the block pin 746 may move to a lowest pin position 748. In the lowest pin position 748 the block pin 746 may block the input extension 714d that connects the cannula 716 to the fluid conduit 714. In the lowest pin position 748 the block pin 746 may (e.g., permanently) block fluid flow from entering the input extension 714d.

FIG. 7G illustrates an additional state after removal of the third syringe from the vial adapter 700. Fixed spring 730 may remain at the first ratchet position 742, and/or the movable spring may (e.g., now) be at the first ratchet position 742. Additionally, or alternatively, as with FIGS. 7C and 7E, compressible member (e.g., and/or safety valve) 720 may be in an expanded state (e.g., no syringe attached, and in some examples blocking fluid flow via output aperture 714a). At this point, the vial adapter 700 may be prevented from use with a fourth syringe, for example since in this position the distal end of the ratcheted slider 728 engages a distal end of the cam space 726 which may prevent further downward movement of the ratcheted slider 728. As a result, the movable spring 724 may be prevented from moving distally via engagement with the ratcheted slider 728. The compressible member 720 (e.g., likewise) may be prevented from compressing, and/or may (e.g., permanently) block the outlet aperture 714a and fluid flow to the syringe connector 710 from the fluid conduit 714. The block pin 746 may remain in the lowest pin position 748.

With further reference to FIGS. 7A-G, an example method of using the vial adapter 700 may include attaching a first syringe, for example resulting in moving the compressible member 720 down. Additionally, or alternatively, attaching a first syringe may result in the ratcheted slider 728 pushing the fixed spring 730 into a locked position during use (e.g., as at FIGS. 7A-7B, into locked position at 734). This may (e.g., then) open up the fluid conduit, for example for transfer of fluid (e.g., diluent or excipient) from the first syringe into the fluid conduit 714. At FIG. 7C, the first syringe may be removed, and the movable spring 724 may slide up to the second ratchet position 738 (e.g., due to the lack of presence of a syringe).

At FIG. 7D, a second syringe may be inserted, for example causing sliding of the ratchet 728 downwards and/or (e.g., also) moving the fixed spring 730 to the third ratchet position 740. Alternatively, or additionally, insertion of a second syringe may also result in opening the fluid flow through conduit 714. At this point, medicament may be withdrawn into the second syringe, and/or removed from the vial adapter 700 (e.g., resulting in the configuration shown in FIG. 7E). At FIG. 7E, the vial adapter 700 may be locked out by virtue of the position of the ratcheted slider 728 within the cam space 726 and/or may not accept a third syringe in some examples. At FIG. 7F, the vial adapter 700 may accept a third syringe, however, for example the third syringe may be unable to extract fluid as the outlet aperture 714a is blocked by the block pin 746. At FIG. 7G the third syringe may not be removable from the syringe connector 710. For example, the outlet aperture 714a may be blocked by the block pin 746. The compressible member 720 (e.g., likewise) may be prevented from compressing, and/or may (e.g., permanently) block the outlet aperture 714a and fluid flow to the syringe connector 710 from the fluid conduit 714.

As discussed herein, the present presents an apparatus, system and method that provides a vial adapter which may be configured to limit the number of times a syringe can be used with an adapter and/or the dose withdrawn through that adapter.

It should be emphasized that the above-described embodiments of the present invention, particularly, any detailed discussion of particular examples are merely possible examples of implementations and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A vial adapter comprising:
a body extending from a proximal end to a distal end;
a syringe connector proximate the proximal end of the body, the syringe connector configured to engage a syringe;
a cannula disposed proximate the distal end of the body, the cannula comprising a pointed tip that is configured to pierce a septum of a vial;
a vial attachment portion at the distal end of the body, the vial attachment portion being configured to attach to the vial;
a fluid conduit extending from an outlet aperture at the syringe connector to the cannula; and
a compressible member disposed within the syringe connector, wherein attachment of a syringe to the syringe connector is configured to axially compress the compressible member from an expanded configuration, in which the compressible member blocks the outlet aperture and prevents fluid flow between the fluid conduit and the syringe connector, to a compressed configuration, in which the outlet aperture is exposed such that the fluid conduit is in fluid communication with the syringe connector.

2. The vial adapter of claim 1, further comprising:
a cam space disposed axially between the syringe connector and the cannula;
a ratcheted slider disposed within the cam space and axially movable through the cam space, the ratcheted slider comprising a plurality of teeth;
a movable spring attached to the compressible member and extending into the cam space, a distal end of the movable spring configured to engage one or more of the plurality of teeth to move the ratcheted slider through the cam space; and
a fixed spring disposed within the cam space and attached to the body, a distal end of the fixed spring configured to engage one or more of the plurality of teeth to prevent proximal movement of the ratcheted slider,
wherein engagement between the ratcheted slider and a distal end of the cam space prevents compression of the compressible member.

3. The vial adapter of claim 2, wherein each tooth of the plurality of teeth defines one of a plurality of ratchet positions for engagement of the movable spring or the fixed spring, the plurality of positions comprising a lowest ratchet position, a second lowest ratchet position proximal to the lowest ratchet position, a third ratchet position proximal to the second lowest ratchet position, a second ratchet position proximal to the third ratchet position, and a first ratchet position proximal to the second ratchet position.

4. The vial adapter of claim 3, wherein the ratcheted slider is configured to engage the distal end of the cam space when the movable spring is in the first ratchet position and the fixed spring is in the third ratchet position.

5. The vial adapter of claim 4, wherein in an initial state the movable spring engages the ratcheted slider in the third ratchet position and the fixed spring engages the ratcheted slider in the lowest ratchet position,
wherein attachment of a first syringe to the syringe connector compresses the compressible member and moves the movable spring distally through the cam space, the movable spring engaging the ratcheted slider to move the ratcheted slider downwards within the cam space such that the fixed spring moves from the lowest ratchet position to the second lowest ratchet position,
wherein subsequent expansion of the compressible member following detachment of the first syringe from the syringe connector moves the movable spring proximally within the cam space, and engagement between the fixed spring and the ratcheted slider prevents proximal movement of the ratcheted slider, such that the fixed spring remains in the second lowest ratchet position and the movable spring moves to the second ratchet position.

6. The vial adapter of claim 5, wherein attachment of a second syringe to the syringe connector compresses the compressible member and moves the movable spring distally through the cam space, the movable spring engaging the ratcheted slider to move the ratcheted slider downwards within the cam space such that the fixed spring moves from the second lowest ratchet position to the third ratchet position,
wherein subsequent expansion of the compressible member following detachment of the second syringe from the syringe connector moves the movable spring proximally within the cam space, and engagement between the fixed spring and the ratcheted slider prevents proximal movement of the ratcheted slider, such that the fixed spring remains in the third ratchet position and the movable spring moves to the first ratchet position,
wherein the ratcheted slider engages the distal end of the cam space when the movable spring is in the first ratchet position and the fixed spring is in the third ratchet position.

7. The vial adapter of claim 1, wherein the compressible member comprises a compressible bellows.

8. The vial adapter of claim 2, wherein the movable spring and the fixed spring comprise metal.

9. The vial adapter of claim 2, wherein the cam space extends axially along an axis that is laterally offset from a central axis of the cannula.

10. The vial adapter of claim 1, wherein the vial attachment portion comprises a flexible skirt extending circumferentially about the cannula.

11. A vial adapter comprising:
a body defining a proximal end and a distal end;
a fluid conduit extending through the body from the proximal end to the distal end, wherein the body defines a circumferential wall at a distal end of the fluid conduit;
a cannula disposed at the distal end of the body, the cannula comprising a pointed tip that is configured to puncture a septum of a vial;
a vial attachment portion disposed about the fluid conduit and configured to engage the vial; and
a gasket disposed within and configured to move axially through the fluid conduit, the gasket comprising a syringe connector configured to engage a syringe and at least one aperture opposite from and in fluid communication with the syringe connector, the aperture being radially offset from a center of the gasket,
wherein the gasket is configured to move through the fluid conduit to a distalmost position, wherein in the distalmost position the gasket engages the circumferential wall so as to block the aperture and prevent fluid flow between the cannula and the syringe connector.

12. The vial adapter of claim 11, wherein the gasket comprises a cam member positioned within a cam track, the cam track disposed within the fluid conduit, and the vial adapter further comprises:
a spring positioned within the fluid conduit and engaged with the gasket so as to bias the gasket towards the proximal end of the body,
wherein the cam track is configured to engage the cam member to control movement of the gasket through the fluid conduit through a plurality of positions, the plurality of positions comprising:
a first position;
a second position distal to the first position, wherein the gasket is configured to move from the first position to the second position upon attachment of the syringe to the gasket, wherein fluid can be transferred between the vial and the syringe in the second position; and
a third position distal to the first position and proximal to the second position, wherein the spring is configured to at least partially move the gasket from the second position to the third position upon disconnection of the syringe from the gasket.

13. The vial adapter of claim 12, wherein the syringe is a first syringe, and the cam track is configured to engage the cam member to further control movement of the gasket through the fluid conduit through the plurality of positions, the plurality of positions further comprising:
a fourth position distal to the second and third positions, wherein the gasket is configured to move from the third position to the fourth position upon attachment of a second syringe to the gasket, wherein fluid can be transferred between the vial and the syringe in the fourth position;
a fifth position proximal to the fourth position and distal to the third position, wherein the spring is configured to at least partially move the gasket from the fourth position to the fifth position upon disconnection of the second syringe from the gasket; and
a sixth position distal to the fourth and fifth positions, wherein the gasket is configured to move from the fifth position to the sixth position upon attachment of a third syringe to the gasket, wherein the gasket engages the circumferential wall in the sixth position.

14. The vial adapter of claim 12, wherein the spring is a coil spring.

15. The vial adapter of claim 14, wherein the spring is positioned coaxially with the cannula.

16. The vial adapter of claim 11, wherein the body is comprised of a first material, and the gasket is comprised of a second material, the second material different than the first material.

17. The vial adapter of claim 16, wherein the body comprises plastic, and the gasket comprises silicone.

18. The vial adapter of claim 11, wherein the vial attachment portion comprises a flexible skirt extending circumferentially about the cannula.

19. The vial adapter of claim 11, wherein the aperture comprises a first aperture and second aperture, the first aperture radially spaced from the second aperture.

20. The vial adapter of claim 11, wherein the aperture comprises a single aperture extending circumferentially about the cannula.

21. A vial adapter comprising:
a main body comprising:
a vial attachment portion configured to engage a vial;
a port defining an internal thread; and
an attachment portion, comprising:
a cannula configured to extend through the main body and at least partially into the vial; and
an external thread configured to engage with the internal thread, such that engagement of the external thread and the internal thread secures the attachment portion to the main body,
wherein incremental advancement of the external thread along the internal thread via rotation of the attachment portion adjusts a distance the cannula extends into the vial.

22. A vial adapter comprising:
a body extending from a proximal end to a distal end;
a syringe connector proximate the proximal end of the body, the syringe connector configured to engage a syringe;
a cannula disposed proximate the distal end of the body, the cannula comprising a pointed tip that is configured to pierce a septum of a vial;
a vial attachment portion at the distal end of the body, the vial attachment portion being configured to attach to the vial;
a fluid conduit extending from an outlet aperture at the syringe connector to the cannula;
a pin channel comprising an interior, the interior fluidly connected to the fluid conduit;
a block pin configured to move within the interior; and
a ratcheted slider configured to contact the block pin, the ratcheted slider configured to axially compress the block pin to a position in which the block pin blocks a fluid connection between the fluid conduit and the cannula.

23. A method of using a vial adapter, the vial adapter comprising a vial attachment portion, a cannula, a syringe connector, a ratcheted slider, a movable spring, a compressible member, and a fluid conduit, wherein the method comprises:
attaching a vial to the vial attachment portion, wherein a septum of the vial is punctured by a pointed tip of the cannula;
attaching a syringe to the syringe connector, wherein attachment of the syringe to the syringe connector causes the compressible member to translate distally, the distal translation of the compressible member causes the movable spring to translate distally, and the distal translation of the movable spring causes the ratcheted slider to translate distally; and
transferring a fluid between the vial and the syringe, wherein the fluid is transferred through the cannula and a fluid conduit, and wherein the fluid conduit extends from an outlet aperture at the syringe connector to the cannula.

24. The method of claim 23, wherein attachment of the syringe to the syringe connector is configured to axially compress the compressible member from an expanded configuration, in which the compressible member blocks the outlet aperture and prevents fluid flow between the fluid conduit and the syringe connector, to a compressed configuration, in which the outlet aperture is exposed such that the fluid conduit is in fluid communication with the syringe connector.

25. The method of claim 23, wherein the vial adapter further comprises a block pin configured to move within a pin channel, and wherein the ratcheted slider is configured to contact the block pin and to axially compress the block pin to a position in which the block pin blocks a fluid connection between the fluid conduit and the cannula.
